(19) United States
(12) Patent Application Publication
(10) Pub. No.: US 2004/0231328 A1
(43) Pub. Date: Nov. 25, 2004

(54) Method for adjusting an internal combustion engine with exhaust gas recirculation and device for carrying out said method

(76) Inventors: Otmar Reider, Rickenbach (CH); Georges Lagier, Savigny (CH)

Correspondence Address: FITCH EVEN TABIN AND FLANNERY, 120 SOUTH LA SALLE STREET, SUITE 1600, CHICAGO, IL, 60603-3406, US

(21) Appl. No.: 10/486,009

(22) PCT Filed: Apr. 24, 2002
(86) PCT No.: PCT/CH02/00228

(30) Foreign Application Priority Data
Aug. 6, 2001 (CH) 1439/01

(51) Int. Cl. F02B 33/44; F02B 47/08; F02M 25/07

(52) U.S. Cl. 60/605.2; 60/278; 123/568.12

(57) ABSTRACT

The invention relates to a method for adjusting a device (1) which essentially consists of a Lambda-1 internal combustion engine (2), a fuel induction line (3), a supplemental unit (9) arranged in the induction line (3) for compressing an air-fuel mixture required for combustion, a catalytic converter (12) arranged in the exhaust gas flow, and an exhaust gas recirculation line (15) which is disposed downstream from the catalytic converter (12), leading into the fuel induction line (3) and which is used to supply cooled exhaust gas to the air-fuel mixture. The inventive method is especially characterized in that the amount of exhaust gas which is to be supplied to the air-fuel mixture per time unit is adjusted according to the combustion chamber temperature measured in the combustion chamber of the internal combustion engine (2) in conjunction with the lambda adjustment. Preferably, said combustion chamber temperature and the amount of exhaust gas to be supplied to the air-fuel mixture per unit of time are measured and adjusted continuously. Especially when the so-called problem gases are used, the useful life of this probe becomes substantially shortened and this, in its turn, leads to high maintenance costs.

### TECHNICAL AREA

The invention relates to a method for adjusting an internal combustion engine with exhaust gas re-circulation and a device for carrying of the method, namely a method in accordance with the preamble of claim 1 and a device in accordance with claim 4.

The device is intended, for instance, for a unit-type heating station with a fixed gas engine.

Successful and economic operation of unit-type heating stations depends essentially on three criteria. The power density, the efficiency and taking due account of the limiting emission values.

The specific emission rates of the combustion products—and among these especially the emission of NO₄— assume a central position among the aforementioned three criteria. This is due to government regulations, which specify maximum NOₓ values of the order of 50 to 80 ng/Nm³ for all units that are operated with fossil fuels. A gas engine, which satisfies this condition with a typical emission of 30 mg/Nm³, has an efficiency of 32%. Although other driving concepts have greater efficiencies, very often their exhaust gas emissions lie above the limiting values imposed by law.

### PRIOR ART

In practice, two types of engines have proved successful for use in unit-type heating stations. These are, first of all, a Lambda-1 internal combustion engine with a three-way catalytic converter and, secondly, a lean-gas engine with a turbocharger, but without a catalytic converter.

In the case of the Lambda-1 internal combustion engine the ratio between the effectively supplied quantity of air and the minimum quantity of air needed for combustion is equal to unity, which means that to the combustion air there is added the stoichiometric quantity of combustion air that is needed in order to oxidize all the oxygen molecules of the air in the combustion reaction. The exhaust gases produced by this combustion method are purified by means of a three-way catalytic converter, so that the exhaust gases leaving the engine are characterized by relatively small emission values that fall short of the aforementioned limiting values. In this case the gas supply to the combustion air is adjusted by means of a lambda probe arranged in the exhaust gas stream, which continuously measures the oxygen content in the exhaust gas stream and then adjusts the required quantity of combustion gas as a function of the measured oxygen content via a steerable control element. Such a Lambda-1 internal combustion engine is however associated with the drawback of having a relatively small efficiency and therefore a small power yield. Although the power yield can be increased by means of supercharging and precompression of the air-fuel mixture, this measure steps up the pressure and temperature in the combustion chamber and thus facilitates the self-ignition of unburnt components of the fuel, so-called knocking, and considerably reduces the useful life of the engine. A Lambda-1 internal combustion engine with supercharger cannot therefore be used for a fixed installation that is to have a long useful life.

In the case of a lean-gas engine the fuel gas is provided with an excess quantity of combustion air in order to keep the combustion temperature as low as possible and to avoid the formation of noxious materials. This technology, which is normally associated with a lambda value of between 1.6 and 1.8, is used, above all, with so-called problem gases, cases in point being sewer gas, dumping ground gas and biogas. When these gases are used as fuel gas, they cannot be used in combination with a three-way catalytic converter, because it is well known that they would destroy it. With a lean-gas engine it is therefore extremely difficult to comply with the limiting emission values prescribed by law, and even when this can be done—for example, by inserting an oxidation catalytic converter in the exhaust gas stream—, it implies a considerable extra cost. To this one has to add the fact that, given the considerable excess air, the power yield of a lean-gas engine is very small. With a view to compensating this disadvantage, the air-fuel mixture is passed into an exhaust gas turbosupercharger and there compressed, where a lambda probe can once again be used to regulate the fuel gas supply. But precisely when the so-called problem gases are used, the useful life of this probe is considerably reduced and this, in its turn, leads to high maintenance costs.

When regulating the two internal combustion engines described above, it is absolutely essential that the ratio between the combustion air and the fuel gas should be continuously corrected during the operation of the engine. When the engine is started, as also when it is operated at less than maximum load or in variable conditions (changes of gas quality, temperature jumps, etc.), the mixture ratio has to be continuously adapted to the changed operating conditions. To this one has to add the fact that, especially in the case of the Lamba-1 gas engine, the lambda range has particularly narrow limits if an acceptable conversion rate of the three-way catalytic converter is to be obtained. Control of the known engines on the basis of these parameters is not optimized and has to be improved if an increased power output is to be obtained.

### BRIEF DESCRIPTIONS OF THE INVENTION

The present invention is underlain by the task of creating a novel method of adjusting a fixed internal combustion engine, especially a gas engine, that will not be associated with the aforesaid difficulties and, in particular, will be free of the drawbacks of the known methods and make it possible to adapt the combustion process as quickly as possible to changing operating conditions in order to obtain, always in conditions of considerable operating safety and a long useful life, as small as possible an emission of noxious material and, at same time, a more efficient power output.

According to the invention, this objective is attained by a method having the characteristics of claim 1 and a device having the characteristics of claim 4.

Advantageous embodiments of the method and the device are described by the dependent claims.

According to the invention, given a Lambda-1 gas engine of the type described hereinabove and equipped with a supplemental unit for compressing the air required for combustion, a certain quantity of the cooled exhaust gas is added to the air-fuel mixture, the addition being controlled as a function of the temperature measured in the combustion chamber of the gas engine. Preferably, the air fuel mixture receives a continuous supply of cooled exhaust gas and, more precisely, in such quantity that the share of exhaust gas in the constituted gas mixture amounts to between 20 and 25% by volume.

The supplemental unit for the compression and combustion of the air-fuel mixture is preferably constituted by a turbosupercharger. The energy the turbosupercharger needs for the compression is obtained by means of a turbine from the exhaust gas.

The combustion process is cooled as a result of the addition of cooled exhaust gas obtained from the catalytic converter. Since practically all the oxygen has been removed from the exhaust gas, it can be added to the stoichiometric air-fuel mixture without the changing the value of lambda. The method in accordance with the invention thus combines the advantages of the known Lambda-1 internal combustion engine with a three-way catalytic converter, which means a greater power density and more extensive application possibilities, with the cooling of the combustion temperature known from lean-gas engines and the consequent longer useful lives.

### BRIEF DESCRIPTION OF THE DRAWINGS

The object of the invention will now be described with the help of an embodiment illustrated by the drawing. The single FIGURE of the drawing shows a schematic layout diagramme of a device in accordance with the invention with a Lambda-1 internal combustion engine and a control device for the controlled recirculation of exhaust gas into the internal combustion engine and or the gas engine.

### DESCRIPTION OF A PREFERRED EMBODIMENT

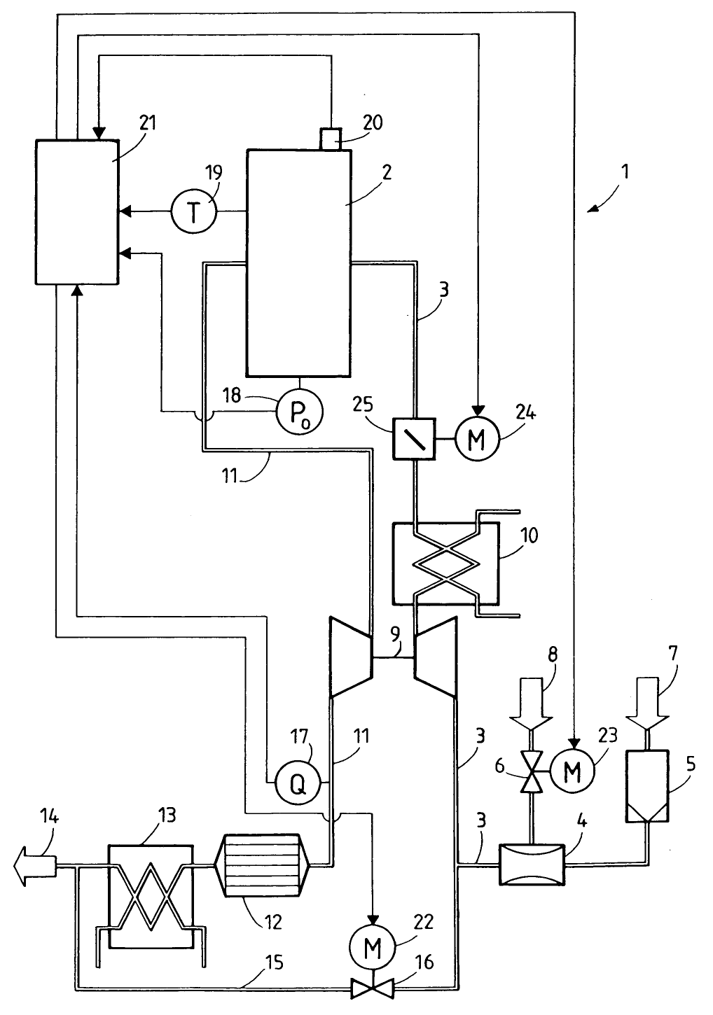

The device, which in FIG. 1 is generically indicated by the reference number 1, comprises a gas engine 2 mounted in a frame not shown in the FIGURE. A fuel induction line 3 leads the air-fuel mixture into the gas engine 2. Associated with this fuel induction line 3 on its input side is a gas mixer 4 into which fuel 8 can be introduced through a shutoff device or valve 6 that can be opened as and when required, while air 7 can be admitted through the filter 5.

In the fuel induction line 3 there is also provided a turbosupercharger 9, which increases the gas throughput of the engine 2 by compressing the gas mixture that is to be burnt and thus makes possible a greater power density. The turbosupercharger 9 is also provided with a cooler 10 for cooling the compressed air-fuel mixture.

An exhaust gas line 11 leads from the gas engine 2 to the three-way catalytic converter 12 with its associated exhaust gas cooler 13. Both are of known construction and are provided with an exhaust gas outlet 14, with an additional exhaust gas recirculation line 15 leading away from the latter. According to the invention, the gas recirculation line comprises the exhaust gas recirculation valve 16 and discharges into the fuel induction line 3.

The device 1 is also equipped with various measurement organs. These comprise a lambda probe 17 arranged in the exhaust gas line 11 in front of the three-way catalytic converter 12, a power measurement device 18 (for measuring the electric power of the generator, for example), at least one temperature probe 19 arranged in the combustion chamber of the gas engine 2 and a knocking sensor 20, likewise arranged in the gas engine 2.

The device 1 is further provided with a control organ 21. This is connected to the control means 22, 23 and 24 of the exhaust gas recirculation valve 16, the gas mixture valve 6 and the control element 25, which may be in the form of a butterfly valve, for example, and in its turn is arranged in the fuel induction line 3—in this area designed as a pressure line—between the turbosupercharger 9 and the engine 2.

The control and monitoring organ 21 preferably also comprises activation organs, indicator instruments and electronic components that make it possible for the system to be controlled and monitored either manually or automatically.

In order to assure an optimal cleansing of the exhaust gas flowing through the exhaust gas line 11 and therefore to obtain the smallest possible emission values, the measured values ascertained by the lambda probe 17 are evaluated by the control organ and, in the light of these measured values and in accordance with a pre-established program, the control organ 23, which may be designed, for example, as a control element with a lambda valve, is controlled in such a manner that the air-gas mixture continuously produced in the gas mixer will at all times during the combustion process have the desired stoichiometric combustion ratio.

The exhaust gas recirculation line 15 with its built-in exhaust gas recirculation valve 16 serves to compensate the previously mentioned factors that exert a negative influence on the device. The valve may be designed, for example, as a regulating valve with a control element and makes it possible for the supply of cooled exhaust gas to the fuel induction line 3 to be controlled by the control organ 21. Preferably, the quantity of exhaust gas that is to be supplied to the air-fuel mixture will be continuously controlled by the control organ 21 as a function of the combustion chamber temperature, preferably also measured on a continuous basis. This temperature is measured by the at least one temperature probe 19, the sensor of which is arranged in one of the several combustion cylinders of the gas engine 2. The fact that the supply of exhaust gas to the combustion process can be controlled makes it possible to adapt the combustion temperature to the changing operating conditions, and this—as already mentioned—without exerting any influence on the stoichiometric ratio between fuel and combustion air. A short reaction time of the control circuit is of decisive importance for the adjustment of the exhaust gas recirculation rate. This condition is satisfied by the direct measurement of the combustion chamber temperature and the control of the exhaust gas recirculation valve 16, which depends directly on this temperature.

The knocking sensor 20, which is likewise connected to the control organ 21, and the control element 25 of the fuel induction line 3 are further components that serve to control the combustion process. The function and control of these components are well known to persons skilled in the art and need not therefore be considered in greater detail.

Used in combination with an exhaust gas recirculation that serves to control the combustion temperature, the method in accordance with the invention and/or the combustion device with a turbosupercharger 9 needed therefor solve several of the problems discussed hereinabove and, as compared with the known methods, assure better performance. The advantages and properties of the method in accordance with the invention and/or the device needed for carrying out this method are as follows:

The continuous and relatively quick-acting adjustment mechanism that controls the combustion temperature makes it possible for the disadvantageous knocking to be effectively suppressed.

Given the use of a Lambda-1 internal combustion engine in combination with a three-way catalytic converter, the device in accordance with the invention produces only low emission values.

Furthermore, the device makes possible a relatively high degree of supercharging and therefore a clear performance improvement. The power density is 1.5 to 2.0 times greater than that associated with the two initially described internal combustion engines and the efficiency is also substantially better than that associated with comparable known devices.

Since the combustion inside the engine 2 is continuously controlled and optimized throughout the time the engine is in operation, it is possible not only to step up the efficiency while maintaining minimal exhaust gas emissions, but also to increase the useful life of the relevant engine components, i.e. the wear and tear associated with the solution in accordance with the invention is clearly smaller than in the known devices.

1. A method for adjusting a device (1) essentially consisting of a Lambda-1 internal combustion engine (2), a fuel induction line (3), a supplemental unit (9) arranged in the fuel induction line (3) for compressing the air fuel mixture needed for combustion, a catalytic converter (12) arranged in the exhaust gas stream and an exhaust gas recirculation line (15) for supplying cooled exhaust gas to the air-fuel mixture arranged downstream of the catalytic converter (12) and discharging into the fuel induction line (3), characterized in that the quantity of exhaust gas supplied to the air-fuel mixture per unit time is adjusted as a function of the temperature measured in the combustion chamber of the internal combustion engine (2).

2. A method in accordance with claim 1, characterized in that the combustion chamber temperature and the quantity of exhaust gas to be supplied to the fuel-gas mixture per unit of time are continually measured and/or controlled, and wherein, for the purpose of adjusting the stoichiometric ratio of the air-fuel mixture, the residual quantity of oxygen in the exhaust gas is measured by means of lambda probe (17).

3. A method in accordance with claim 1, characterized in that cooled exhaust gas is supplied to the air-fuel mixture in such quantity that the combustion temperature will not exceed a predetermined value, and wherein the proportion of exhaust gas contained in the constituted gas mixture depends on the power of the internal combustion engine.

4. A device for carrying out the method in accordance with claim 1, characterized by
a Lambda-1 internal combustion engine (2) with a fuel induction line (3),
a supplemental unit (9) arranged in the fuel induction line (3) for compressing the air-fuel mixture required for combustion,
a catalytic converter (12) arranged in the exhaust gas stream,
an exhaust gas recirculation line (15) arranged downstream of the catalytic converter (12) and leading into the exhaust gar recirculation line (15),
at least one temperature probe (19) arranged in the internal combustion engine (2), and
a control organ (21) for controlling the quantity of exhaust gas to be supplied through the exhaust gas recirculation line (15) per unit of time in accordance with the combustion chamber temperature measured by the at least one temperature probe (19).

5. A device in accordance with claim 4, characterized in that the internal combustion engine (2) is a gas engine.

6. A device in accordance with claim 4, characterized in that the supplemental unit (9) for the compression and combustion of the air-fuel mixture is a turbosupercharger.

7. A device in accordance with claim 4, characterized in that the catalytic converter (12) is a three-way catalytic converter.

8. A device in accordance with claim 4, characterized by a lambda probe (17) arranged in the exhaust gas line upstream of the catalytic converter (12), a power measurement device (18) and a knocking sensor (20) arranged in the internal combustion engine (2), said measurement organs being likewise connected to the central control organ (21).
